(19) United States
(12) Patent Application Publication
(10) Pub. No.: US 2021/0096478 A1
(43) Pub. Date: Apr. 1, 2021

(54) TONER

(71) Applicant: KYOCERA Document Solutions Inc., Osaka (JP)

(72) Inventors: Seiji KIKUSHIMA, Osaka-shi (JP); Takahiro HAMADA, Osaka-shi (JP)

(73) Assignee: KYOCERA Document Solutions Inc., Osaka (JP)

(21) Appl. No.: 17/036,063

(22) Filed: Sep. 29, 2020

(30) Foreign Application Priority Data
Sep. 30, 2019 (JP) 2019-179241

(51) Int. Cl. G03G 9/097; G03G 9/087; G03G 9/08; C08G 63/185; C08F 220/34

(52) U.S. Cl. CPC G03G 9/09775; G03G 9/08788; C08F 220/34; C08G 63/185; G03G 9/08755; G03G 9/0823

(57) ABSTRACT

A toner includes toner particles. The toner particles each include a toner mother particle. The toner mother particles contain a binder resin, a magnetic powder, and a charge control agent. The binder resin includes a block polymer. The block polymer has a polyester portion and a vinyl polymer portion. The charge control agent includes a styrene-acrylic resin having a quaternary ammonium group. A content percentage of the charge control agent in the toner mother particles is at least 1.5% by mass and no greater than 12.0% by mass.

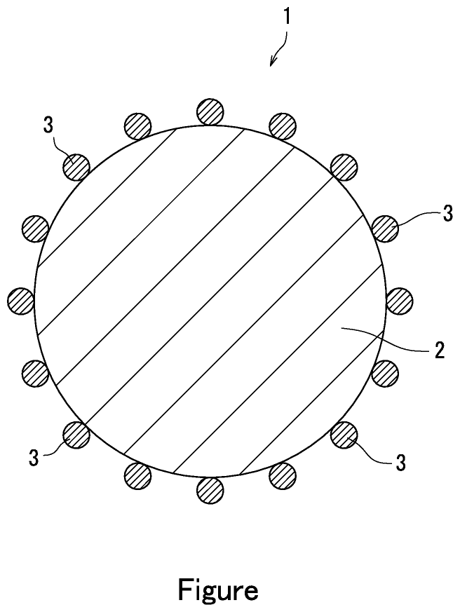

### INCORPORATION BY REFERENCE

The present application claims priority under 35 U.S.C. § 119 to Japanese Patent Application No. 2019-179241, filed on Sep. 30, 2019. The contents of this application are incorporated herein by reference in their entirety.

### BACKGROUND

The present disclosure relates to a toner.

A toner including toner particles is used in electrophotographic image formation. The toner particles each include a toner mother particle containing for example a binder resin and a magnetic powder. A toner including toner particles such as above is used as a one-component developer.

A toner to be used as a one-component developer is required to be excellent in developability and enable formation of an image having sufficient image density. As a toner excellent in developability, a toner containing a block polymer having a polyester portion and a vinyl polymer portion as a binder resin has been proposed, for example.

### SUMMARY

A toner according to an aspect of the present disclosure includes toner particles. The toner particles each include a toner mother particle. The toner mother particles contain a binder resin, a magnetic powder, and a charge control agent. The binder resin includes a block polymer. The block polymer has a polyester portion and a vinyl polymer portion. The charge control agent includes a styrene-acrylic resin having a quaternary ammonium group. A content percentage of the charge control agent in the toner mother particles is at least 1.5% by mass and no greater than 12.0% by mass.

### BRIEF DESCRIPTION OF THE DRAWING

FIGURE is a cross-sectional view of an example of a toner particle included in a toner according to the present disclosure.

### DETAILED DESCRIPTION

The following describes a preferred embodiment of the present disclosure. Note that a toner refers to a collection (for example, a powder) of toner particles. An external additive refers to a collection (for example, a powder) of external additive particles. Evaluation results (for example, values indicating a shape and properties) for a powder (specific examples include a powder of toner particles and a powder of external additive particles) are each a number average of values measured with respect to a suitable number of particles selected from the powder, unless otherwise stated.

Values for volume median diameter (D₅₀) of a powder are values measured based on the Coulter principle (electrical sensing zone technique) using “Coulter Counter Multisizer 3” produced by Beckman Coulter, Inc. unless otherwise stated.

Unless otherwise stated, a number average primary particle diameter of a powder is a number average value of equivalent circle diameters of primary particles of the powder (Heywood diameters: diameters of circles having the same areas as projected areas of the respective primary particles) measured using a scanning electron microscope. The number average primary particle diameter of a powder is a number average value of equivalent circle diameters of for example 100 primary particles. Note that a number average primary particle diameter of particles is a number average primary particle diameter of particles of a powder unless otherwise stated.

Chargeability refers to chargeability in triboelectric charging unless otherwise stated. A measurement target (for example, a toner) is triboelectrically charged for example by mixing and stirring the measurement target with a standard carrier (standard carrier for a negatively chargeable toner: N-01, standard carrier for a positively chargeable toner: P-01) provided by the Imaging Society of Japan. An amount of charge of the measurement target is measured before and after triboelectric charging using for example a compact draw-off charge measurement system (“MODEL 212HS”, product of TREK, Inc.). A measurement target having a larger change in amount of charge between before and after the triboelectric charging has stronger chargeability.

Unless otherwise stated, a “main component” of a material refers to a component contained the most in the material in terms of mass.

Values for a softening point (Tm) are values measured using a capillary rheometer (“CFT-500D”, product of Shimadzu Corporation) unless otherwise stated. On an S-shaped curve (horizontal axis: temperature, vertical axis: stroke) plotted using the capillary rheometer, the softening point (Tm) is a temperature corresponding to a value of “(base line stroke value+maximum stroke value)/2”.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. In the present description, the term “(meth)acryl” is used as a generic term for both acryl and methacryl.

### <Toner>

A toner according to an embodiment of the present disclosure includes toner particles. The toner particles each include a toner mother particle. The toner mother particles contain a binder resin, a magnetic powder, and a charge control agent. The binder resin includes a block polymer. The block polymer has a polyester portion and a vinyl polymer portion. The charge control agent includes a styrene-acrylic resin having a quaternary ammonium group (also referred to below as a specific styrene-acrylic resin). A content percentage of the charge control agent in the toner mother particles is at least 1.5% by mass and no greater than 12.0% by mass.

The toner according to the present disclosure can be used as for example a positively chargeable magnetic toner (one-component developer) for development of electrostatic latent images.

As a result of having the above constitution, the toner according to the present disclosure is excellent in developability and can inhibit occurrence of toner layer turbulence on a development sleeve. The following describes toner layer turbulence on a development sleeve. In image formation using a one-component developer, an image force acts on the toner and the development sleeve. Due to the image force, the toner adheres to the development sleeve. As a result, a toner layer containing the toner is formed on the development sleeve. The toner contained in the toner layer is used for development as needed. However, when the image force acting on the toner and the development sleeve is excessively great, part of the toner contained in the toner layer (specifically, the toner in an area closer to the development sleeve in the thickness direction of the toner layer) firmly adheres to the development sleeve and tends not to be used for development. As a result, unevenness occurs in the toner layer. The phenomenon is called toner layer turbulence on a development sleeve. The toner layer turbulence on a development sleeve serves as a cause of density unevenness in a formed image.

The following describes a reason why the toner according to the present disclosure is excellent in developability and can inhibit occurrence of toner layer turbulence on a development sleeve. In the following description, as to the thickness direction of the toner layer, the direction toward the development sleeve may be referred to as “down”, and the direction away from the development sleeve may be referred to as “up”. First, the mechanism by which the toner layer formed on the development sleeve is charged will be described. In the toner layer, downmost toner particles (toner particles in direct contact with the development sleeve) are charged by friction with the development sleeve. Then, charge transfer occurs from the charged downmost toner particles to adjacent toner particles. As such, upper toner particles in the toner layer are sequentially charged and finally all the toner particles contained in the toner layer are charged. The transfer rate of charge in the toner layer tends to depend on the time constant τ of the toner (product of electric resistance and permittivity of the toner). Specifically, a toner layer formed from a toner having a small time constant τ tends to have a high charge transfer rate and a narrow charge amount distribution of the toner (all the toner particles contained in the toner layer are stably charged). A narrower charge amount distribution of the toner contained in the toner layer results in an increased developability of the toner and an increased image density of a formed image. Further, a phenomenon of charge injection into the toner layer occurs in a developing nip part due to an electric field acting on the toner. A large amount of charge tends to be injected into a toner layer formed from a toner having a small time constant τ by the above-mentioned phenomenon. Injection of a large amount of charge into the toner layer further increases developability of the toner. However, a toner layer formed from a toner having an excessively small time constant τ tends to have a reduced thickness due to reduction in amount of charge (charge neutralization) as a result of charge transfer from the downmost toner particles to the development sleeve. The thickness reduction of the toner layer decreases developability of the toner. From the above, the toner preferably has an appropriately small time constant τ from the viewpoint of developability.

The time constant τ of the toner according to the present disclosure is determined mainly depending on dispersibility of the specific styrene-acrylic resin in the toner mother particles. Specifically, when the specific styrene-acrylic resin is highly dispersed in the toner mother particles, the toner has a high electric resistance and thus tends to have a large time constant τ. The toner mother particles included in the toner according to the present disclosure contain a block polymer as a binder resin. The block polymer has a vinyl polymer portion having a high affinity for the specific styrene-acrylic resin and a polyester portion having a low affinity for the specific styrene-acrylic resin. As a result, the block polymer inhibits excessive dispersion of the specific styrene-acrylic resin. As described above, the toner according to the present disclosure is excellent in developability because the time constant τ is adjusted to be appropriately low by using the specific styrene-acrylic resin and the block polymer in combination.

Further, the higher the content percentage of the charge control agent in the toner mother particles is, the lower the time constant τ of the toner tends to be. Therefore, the content percentage of the charge control agent is preferably high to a certain extent. However, a toner having an excessively high content percentage of the charge control agent tends to be excessively charged and adhere firmly to the development sleeve, causing toner layer turbulence. By contrast, the toner according to the present disclosure having a content percentage of the charge control agent of at least 1.5% by mass and no greater than 12.0% by mass can inhibit toner layer turbulence on a development sleeve while exhibiting an excellent developability.

### [Time Constant τ]

The toner according to the present disclosure preferably has a time constant τ (product of electric resistance and permittivity of the toner) of at least 0.10 seconds and no greater than 20.00 seconds at a temperature of 20° C. and a relative humidity of 65%, and more preferably at least 0.50 seconds and no greater than 5.00 seconds. As a result of the time constant τ of the toner according to the present disclosure being at least 0.10 seconds and no greater than 20.00 seconds, the charge amount distribution of the toner in the toner layer formed on the development sleeve is narrowed. Consequently, the toner according to the present disclosure can exhibit further excellent developability. The time constant τ of the toner according to the present disclosure is measured by a method described in association with Examples or a method based thereon. The time constant τ of the toner according to the present disclosure can be adjusted for example by changing the type of the binder resin or the type and content percentage of the charge control agent. Specifically, the higher the content percentage of the charge control agent in the toner mother particles is, the lower the time constant τ of the toner according to the present disclosure tends to be.

### [Isoelectric Point]

The toner according to the present disclosure preferably has an isoelectric point as measured by zeta potential measurement in water (pH at which the zeta potential becomes 0) of at least 3.00 and no greater than 5.00, and more preferably at least 3.00 and no greater than 4.00. As a result of the isoelectric point of the toner according to the present disclosure being at least 3.00, developability can be further improved. As a result of the isoelectric point of the toner according to the present disclosure being no greater than 5.00, toner layer turbulence on the development sleeve can be further effectively inhibited. The isoelectric point of the toner according to the present disclosure is measured by a method described in association with Examples or a method based thereon. The isoelectric point of the toner according to the present disclosure can be adjusted for example by changing the type and content percentage of the charge control agent. Specifically, the higher the content percentage of the charge control agent in the toner mother particles is, the higher the isoelectric point of the toner according to the present disclosure tends to be.

The above-described isoelectric point is an index indicating a work function difference between the developing sleeve and the toner. Specific explanation is as follows. Highly accurate measurement of the work function of a toner is difficult. For this reason, in order to appropriately design the work function difference between the developing sleeve and the toner, the above-described isoelectric point that correlates with the work function of the toner is adjusted. A toner having the above-described isoelectric point (pH at which the zeta potential becomes 0) of at least 3.00 and no greater than 5.00 tends to exhibit appropriate chargeability for a positively chargeable toner.

The following describes the toner further in detail. Note that one of components listed in the following description may be used singly or two or more of the components may be used in combination unless otherwise stated.

### [Toner Particles]

FIGURE illustrates an example of a toner particle 1 included in the toner. The toner particle 1 illustrated in FIGURE includes a toner mother particle 2 and an external additive attached to a surface of the toner mother particle 2. The external additive includes external additive particles 3.

However, the toner particles may have a structure different from that of the toner particle 1 illustrated in FIGURE. Specifically, the toner particles may include no external additive. The toner particles have been described in detail with reference to FIGURE.

### [Toner Mother Particles]

The toner mother particles contain a binder resin, a magnetic powder, and a charge control agent. The toner mother particles may further contain an internal additive (for example, at least one of a releasing agent and a colorant) as necessary.

In terms of favorable image formation, the toner mother particles preferably have a volume median diameter (D₅₀) of at least 4 μm and no greater than 9 μm.

### (Binder Resin)

The toner mother particles contain for example a binder resin as a main component. The binder resin includes a block polymer. The binder resin may further include another resin (specific examples include polyester resin and a vinyl resin) in addition to the block polymer.

The content percentage of the binder resin in the toner mother particles is preferably at least 30% by mass and no greater than 90% by mass, and more preferably at least 40% by mass and no greater than 70% by mass.

### (Block Polymer)

The block polymer has a polyester portion and a vinyl polymer portion. The block polymer may further have a linker that links the polyester portion to the vinyl polymer portion. The linker is derived from a specific compound (also referred to below as a bireactive monomer) having for example a vinyl group and at least one of a carboxy group and an alcoholic hydroxyl group.

The vinyl polymer portion in the block polymer includes a repeating unit derived from a vinyl compound. The vinyl compound is a compound having a vinyl group (CH₂═CH—) or a group in which hydrogen in the vinyl group is replaced (however, compounds corresponding to bireactive monomers are excluded). The vinyl compound forms the vinyl polymer portion through addition polymerization due to the presence of a carbon-carbon double bond (C═C) contained in a vinyl group or a group in which hydrogen in the vinyl group is replaced.

Examples of the vinyl compound include styrene-based compounds, alkyl (meth)acrylates, phenyl (meth)acrylate, (meth)acrylonitrile, and vinyl chloride.

Examples of the styrene-based compounds include styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene.

Examples of the alkyl (meth)acrylates include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-octyl (meth)acrylate, 2-ethylhexyl (meth)acrylate, stearyl (meth)acrylate, and lauryl (meth)acrylate.

Examples of the (meth)acrylic acid phenyl esters include phenyl (meth)acrylate.

The vinyl compound is preferably a styrene compound, and more preferably styrene.

The polyester portion in the block polymer includes a repeating unit formed by condensation polymerization of at least one polyhydric alcohol and at least one polybasic carboxylic acid. Examples of the polyhydric alcohol include dihydric alcohols (for example, diols and bisphenols) and tri- or higher-hydric alcohols listed below. Examples of the polybasic carboxylic acid include dibasic carboxylic acids and tri- or higher-basic carboxylic acids listed below. Note that a polybasic carboxylic acid derivative that can form an ester bond through condensation polymerization (for example, an anhydride of a polybasic carboxylic acid and a halide of polybasic carboxylic acid) may be used instead of the polybasic carboxylic acid.

Examples of the diols include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenols include bisphenol A, hydrogenated bisphenol A, bisphenol A-ethylene oxide adduct, and bisphenol A-propylene oxide adduct.

Examples of the tri- or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, dodecane diacid, azelaic acid, malonic acid, succinic acid, alkyl succinic acids (for example, n-butyl succinic acid, isobutyl succinic acid, n-octyl succinic acid, n-dodecyl succinic acid, and isododecyl succinic acid), and alkenyl succinic acids (for example, n-butenyl succinic acid, isobutenyl succinic acid, n-octenyl succinic acid, n-dodecenyl succinic acid, and isododecenyl succinic acid).

Examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxy)methane, 1,2,7,8-octanetetracarboxylic acid, pyromellitic acid, and empol trimer acid.

The polybasic carboxylic acid in the block polymer is preferably terephthalic acid or isophthalic acid. The polyhydric alcohol in the block polymer is preferably bisphenol A-ethylene oxide adduct, bisphenol A-propylene oxide adduct, or ethylene glycol.

In terms of facilitating synthesis of the block polymer, the bireactive monomer for formation of a linker is preferably a compound having a single vinyl group and a single carboxy group, or a compound having a single vinyl group and a single hydroxyl group.

Examples of the bireactive monomer include (meth)acrylic acid, a hydroxyalkyl (meth)acrylate, fumaric acid, and maleic acid. The bireactive monomer is preferably acrylic acid.

Whether or not the binder resin includes the block polymer can be confirmed by gas chromatography-mass spectroscopy (GC-MS) analysis, for example. Specifically, it can be confirmed that the block polymer is included in the binding resin when a fragment ion having a linker derived from the bireactive monomer, a fragment of the vinyl polymer portion, and a fragment of the polyester portion are detected through GC-MS analysis on the toner according to the present disclosure.

### (Polyester Resin)

The polyester resin can be obtained by condensation polymerization of at least one polyhydric alcohol and at least one polybasic carboxylic acid. Examples of a polyhydric alcohol and a polybasic carboxylic acid that can be used as raw materials of the polyester resin include the same compounds as the polyhydric alcohols and the polycarboxylic acids listed as raw materials of the above-described block polymer.

The polyester resin is preferably a condensation polymer of terephthalic acid, bisphenol A-ethylene oxide adduct, and ethylene glycol; a condensation polymer of terephthalic acid, bisphenol A-ethylene oxide adduct, and bisphenol A-propylene oxide adduct; or a condensation polymer of isophthalic acid, bisphenol A-ethylene oxide adduct, and ethylene glycol.

### (Vinyl Resin)

A vinyl resin is a polymer of a monomer containing a vinyl compound. Examples of a vinyl compound that can be used as a raw material of the vinyl resin include the same compounds as the vinyl compounds listed as the raw materials of the above-described block polymer.

The vinyl resin is preferably a polymer of a monomer containing a styrene-based compound, and more preferably a polystyrene resin.

A total content percentage of the block polymer, the polyester resin, and the vinyl resin in the binder resin is preferably at least 90% by mass, and more preferably 100% by mass.

The binder resin has a softening point of for example 110° C. or higher and 130.0° C. or lower.

### (Binder Resin Synthesis Method)

The binder resin can be synthesized by a method including an addition polymerization of a polyester resin, a bireactive monomer, and a vinyl compound, for example. In the synthesis method, first, a carboxy group or a hydroxyl group at a terminal of the polyester resin and a carboxy group or a hydroxyl group in the bireactive monomer undergo condensation. As a result, a repeating unit derived from the bireactive monomer is introduced into the terminal of the polyester resin. Next, the bireactive monomer introduced into the terminal of the polyester resin and the vinyl compound undergo addition polymerization. Through the above, a block polymer is obtained that has a polyester portion derived from the polyester resin, a linker derived from the bireactive monomer, and a vinyl polymer portion derived from the vinyl compound. Specifically, a block polymer is obtained that has a polyester portion derived from the polyester resin, a linker linked to a terminal of the polyester portion, and a vinyl polymer portion linked to the linker.

In the addition polymerization, part of the polyester resin may remain in the reaction system without reacting with the bireactive monomer. In addition, part of the vinyl compound may react only with another portion of the vinyl compound or the bireactive monomer to form a vinyl resin. That is, the binder resin obtained by the above-described synthesis method may contain the polyester resin and the vinyl resin in addition to the block polymer.

In the addition polymerization, a polybasic carboxylic acid (or an anhydride thereof) may be further added in addition to the polyester resin, the bireactive monomer, and the vinyl compound. By further adding a polybasic carboxylic acid, the acid value of the polyester resin can be increased, and as a result, the acid value of the binder resin thus synthesized can be increased. The polycarboxylic acid is preferably trimellitic acid. The amount of the polybasic carboxylic acid to be added is for example at least 5 parts by mass and no greater than 30 parts by mass relative to 100 parts by mass of the polyester resin. The polyester resin, the bireactive monomer, and the vinyl compound, as well as the polybasic carboxylic acid added as necessary may be referred to below collectively as “reaction materials”.

The total percentage of the polyester resin and the polybasic carboxylic acid relative to the total amount of the reaction materials is preferably at least 50.0% by mass and no greater than 90.0% by mass, and more preferably at least 60.0% by mass and no greater than 80.0% by mass.

The percentage of the bireactive monomer relative to the total amount of the reaction materials is preferably at least 0.1% by mass and no greater than 5.0% by mass, and more preferably at least 0.5% by mass and no greater than 2.0% by mass.

The percentage of the vinyl compound relative to the total amount of the reaction materials is preferably at least 10.0% by mass and no greater than 50.0% by mass, and more preferably at least 20.0% by mass and no greater than 35.0% by mass.

In the addition polymerization, a known radical polymerization initiator (for example, dicumyl peroxide) is preferably added. The amount of the radical polymerization initiator to be added is for example at least 0.5 parts by mass and no greater than 4.0 parts by mass relative to 100 parts by mass of the total amount of the reaction materials.

### (Magnetic Powder)

Examples of materials of the magnetic powder include ferromagnetic metals (for example, iron, cobalt, nickel, and alloys including at least one of these metals), ferromagnetic metal oxides (for example, ferrite, magnetite, and chromium dioxide), and materials subjected to ferromagnetization (for example, carbon materials to which ferromagnetism is imparted through thermal treatment).

In terms of favorable image formation, the amount of the magnetic powder contained in the toner mother particles is preferably at least 40 parts by mass and no greater than 120 parts by mass relative to 100 parts by mass of the binder resin, and more preferably at least 60 parts by mass and no greater than 90 parts by mass.

The magnetic powder preferably has a number average primary particle diameter of at least 0.1 μm and no greater than 1.0 μm, and more preferably at least 0.1 μm and no greater than 0.3 μm.

The magnetic powder is preferably subjected to surface treatment in order to inhibit elution of metal ions (for example, iron ions) from the magnetic powder.

Elution of metal ions to surfaces of the toner mother particles tends to lead adhesion of toner mother particles to one another. It is thought that inhibition of metal ion elution from the magnetic powder can inhibit adhesion of toner mother particles to one another.

### (Charge Control Agent)

The charge control agent contains a specific styrene-acrylic resin. The styrene-acrylic resin is a resin including a repeating unit derived from a styrene-based compound (for example, styrene) and a repeating unit derived from (meth)acrylic acid or an alkyl (meth)acrylate. The charge control agent preferably contains only the specific styrene-acrylic resin.

A content percentage of the charge control agent in the toner mother particles is at least 1.5% by mass and no greater than 12.0% by mass, and preferably at least 3.0% by mass and no greater than 8.0% by mass. As a result of the content percentage of the charge control agent being at least 1.5% by mass, developability of the toner according to the present disclosure can be improved. As a result of the content percentage of the charge control agent being no greater than 12.0% by mass, occurrence of toner layer turbulence on the development sleeve can be inhibited.

The quaternary ammonium group is preferably a group represented by general formula (—N⁺R¹R²R³). Here, R¹ to R³ each represent, independently of one another, an alkyl group having a carbon number of at least 1 and no greater than 5. R¹ to R³ each preferably represent, independently of one another, a methyl group or an ethyl group.

The specific styrene-acrylic resin preferably includes a repeating unit derived from a compound represented by the following general formula (1) (also referred to below as a compound (A)).

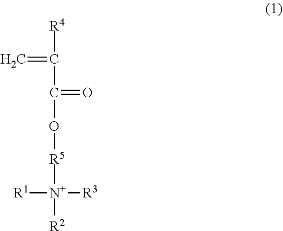

In general formula (1), R¹ to R³ each represent, independently of one another, an alkyl group having a carbon number of at least 1 and no greater than 5. R⁴ represents a hydrogen atom or a methyl group. R⁵ represents an alkylene group having a carbon number of at least 1 and no greater than 5.

In general formula (1), R¹ to R³ each preferably represent, independently of one another, a methyl group or an ethyl group. R⁵ preferably represents an ethylene group.

The compound (A) can be obtained by for example a reaction (quaternization) of a dialkylaminoalkyl (meth)acrylate and an alkyl paratoluenesulfonate. Specifically, a salt of the compound (A) is obtained by the above-mentioned quaternization.

Examples of the dialkylaminoalkyl (meth)acrylate include dimethylaminoethyl (meth)acrylate, diethylaminoethyl (meth)acrylate, dipropylaminoethyl (meth)acrylate, and dibutylaminoethyl (meth)acrylate. The dialkylaminoalkyl (meth)acrylate is preferably diethylaminoethyl (meth)acrylate.

Examples of the alkyl paratoluenesulfonate include methyl paratoluene sulfonate, ethyl paratoluene sulfonate, and propyl paratoluene sulfonate. The alkyl paratoluenesulfonate is preferably methyl paratoluene sulfonate in terms of reactivity.

In the above-mentioned quaternization, an amount of the alkyl paratoluenesulfonate used is preferably at least 0.8 mol and no greater than 1.5 mol relative to 1 mol of the dialkylaminoalkyl (meth)acrylate, and more preferably at least 1.0 mol and no greater than 1.2 mol.

The specific styrene-acrylic resin preferably further includes at least one of a repeating unit derived from a styrene-based compound and a repeating unit derived from alkyl (meth)acrylate in addition to the repeating unit derived from the compound (A). Examples of the styrene-based compound and the alkyl (meth)acrylate that can be used as raw materials of the specific styrene-acrylic resin include the same compounds as the styrene-based compounds and the alkyl (meth)acrylates listed as the raw materials of the above-described block polymer.

The percentage of the repeating unit derived from the compound (A) relative to all repeating units in the specific styrene-acrylic resin is preferably at least 20 mol % and no greater than 60 mol %, and more preferably at least 30 mol % and no greater than 45 mol %. As a result of the percentage of the repeating unit derived from the compound (A) being at least 20 mol %, sufficient chargeability of the toner according to the present disclosure can be secured. As a result of the percentage of the repeating unit derived from the compound (A) being no greater than 60 mol %, compatibility of the specific styrene-acrylic resin with the binder resin can be improved. Consequently, the toner according to the present disclosure has improved moisture resistance.

The specific styrene-acrylic resin can be synthesized by for example mixing monomers (a salt of the compound (A), and a styrene compound and an alkyl (meth)acrylate that are used as necessary) together and subjecting the mixed monomers to copolymerization in presence of a polymerization initiator. The obtained specific styrene-acrylic resin may be directly used as a charge control agent or used as a charge control agent after being reacted with a quaternary ammonium salt (for example, benzyltributylammonium-4-hydroxynaphthalene-1-sulfonate).

Examples of a method of the copolymerization include solution polymerization, suspension polymerization, bulk polymerization, and emulsion polymerization. Examples of the solvent used in the solution polymerization include ketone solvents (for example, methyl ethyl ketone and methyl isobutyl ketone), alcohol solvents (for example, normal butanol and isobutanol), ester solvents (for example, ethyl acetate and isobutyl acetate), and aromatic hydrocarbon solvents (for example, toluene and xylene). The solvent is preferably an alcohol solvent, and more preferably isobutanol.

Examples of the polymerization initiator include peroxide initiators (for example, t-butylperoxy-2-ethylhexanoate, t-amylperoxy-2-ethylhexanoate, 1,1-di(t-butylperoxy)cyclohexane, and dibenzoyl peroxide), and azo-based initiators (for example, 2,2′-azobis(2-methylbutyronitrile)). An amount of the polymerization initiator used is for example at least 0.5 parts by mass and no greater than 20 parts by mass relative to 100 parts by mass of the monomers.

### (Releasing Agent)

The toner mother particles may contain a releasing agent. The releasing agent is for example used in order to impart hot offset resistance to the toner according to the present disclosure.

Examples of the releasing agent include aliphatic hydrocarbon-based waxes (for example, low molecular weight polyethylene, low molecular weight polypropylene, polyolefin copolymers, polyolefin wax, microcrystalline wax, paraffin wax, and Fischer-Tropsch wax), oxides of aliphatic hydrocarbon-based waxes (for example, polyethylene oxide wax and block copolymers of polyethylene oxide wax), plant waxes (for example, candelilla wax, carnauba wax, Japan wax, jojoba wax, and rice wax), animal waxes (for example, beeswax, lanolin, and spermaceti), mineral waxes (for example, ozokerite, ceresin, and petrolatum), ester waxes containing a fatty acid ester as a main component (for example, montanic acid ester wax and castor wax), and waxes in which part or all of a fatty acid ester has been deoxidized (for example, deoxidized carnauba wax). Preferably, the releasing agent is carnauba wax.

When the toner mother particles contain a releasing agent, the amount of the releasing agent in the toner mother particles is preferably at least 1 part by mass and no greater than 20 parts by mass relative to 100 parts by mass of the binder resin, and more preferably at least 5 parts by mass and no greater than 12 parts by mass. As a result of the amount of the releasing agent being at least 1 part by mass and no greater than 20 parts by mass, hot offset resistance of the toner according to the present disclosure can be improved.

When the toner mother particles contain a releasing agent, the toner mother particles may further contain a compatibilizer in order to improve compatibility between the binder resin and the releasing agent.

### (Colorant)

The toner mother particles may contain a colorant. The colorant may be a known pigment or dye that matches the color of the toner.

The toner mother particles may contain a black colorant. Carbon black can for example be used as a black colorant. Alternatively, a colorant can be used that has been adjusted to a black color using a yellow colorant, a magenta colorant, and a cyan colorant. A magnetic powder may be used as the black colorant. That is, the toner mother particles need not contain a colorant other than the magnetic powder.

### [External Additive]

The toner particles preferably each include an external additive attached to a surface of the toner mother particle. The external additive includes external additive particles. The external additive particles are preferably inorganic particles. Examples of the inorganic particles include silica particles (particularly dry silica particles) and particles of metal oxides (for example, alumina, titanium oxide, magnesium oxide, zinc oxide, strontium titanate, and barium titanate). The inorganic particles are preferably silica particles. The inorganic particles preferably have a number average primary particle diameter of at least 1 nm and no greater than 100 nm, and more preferably at least 5 nm and no greater than 40 nm.

When the toner particles include an external additive, the amount of the external additive is preferably at least 0.01 parts by mass and no greater than 10 parts by mass relative to 100 parts by mass of the toner mother particles, and more preferably at least 0.1 parts by mass and no greater than 5 parts by mass.

### [Toner Production Method]

The following describes an example of a production method of the toner according to the present disclosure. The production method of the toner includes a toner mother particle preparation process for preparing the toner mother particles. The production method of the toner may further include another process (for example, an external addition process described later) in addition to the toner mother particle preparation process.

### (Toner Mother Particle Preparing Process)

In the toner mother particle preparation process, the toner mother particles are prepared for example by a pulverization method or an aggregation method.

In an example of the pulverization method, the binder resin, the magnetic powder, the charge control agent, and another internal additive optionally added depending on necessity thereof are mixed together first. Subsequently, the resultant mixture is melt-kneaded using a melt-kneader (for example, a single or twin screw extruder). Next, the resultant melt-kneaded product is pulverized and classified. Through the above, the toner mother particles are obtained.

In an example of the aggregation method, respective types of fine particles of the binder resin, the magnetic powder, and the charge control agent, and another internal additive optionally added depending on necessity thereof are caused to aggregate in an aqueous medium including the fine particles of these types until the fine particles have a desired particle diameter. Through aggregation as above, aggregated particles containing the binder resin and the others are formed. Subsequently, the aggregated particles are heated to cause components contained in the aggregated particles to coalesce. Through the above, the toner mother particles are obtained.

### (External Addition Process)

In the present process, an external additive is attached to surfaces of the toner mother particles. Examples of a method for attaching the external additive to the surfaces of the toner mother particles include a method in which the toner mother particles and external additive particles are stirred and mixed using for example a mixer.

### EXAMPLES

The following provides more specific description of the present disclosure through use of Examples. However, it should be noted that the present disclosure is not limited to the scope of Examples.

### [Synthesis of Binder Resins]

Binder resins (BP-a) to (BP-c), (PEs), and (St) were synthesized by the following methods. The binder resins (BP-a) to (BP-c) included a block polymer having a polyester portion and a vinyl polymer portion. The binder resin (PEs) included a polyester resin. The binder resin (St) included a styrene resin.

### (Binder Resin (BP-a))

A 10-L four-necked flask equipped with a thermometer, a stainless steel stirring rod, a falling-type condenser, and a nitrogen inlet tube was used as a reaction vessel. Into the reaction vessel, 810 g of terephthalic acid, 585 g of bisphenol A-ethylene oxide adduct, and 340 g of ethylene glycol were added. Next, the air in the reaction vessel was replaced with nitrogen gas. The reaction vessel was placed on a heating mantle, and the temperature of the reaction vessel contents was increased to 250° C. The reaction vessel contents were kept at 250° C. for 4 hours for condensation polymerization (first condensation polymerization). After the first condensation polymerization, the reaction vessel contents were cooled to 160° C. After the cooling, 288 g of trimellitic anhydride was added into the reaction vessel while the temperature of the reaction vessel contents was kept at 160° C. Subsequently, a mixture of 818 g of styrene, 38 g of acrylic acid, and 50 g of dicumyl peroxide was dripped into the reaction vessel under stirring of the reaction vessel contents over 1 hour while the temperature of the reaction vessel contents was kept at 160° C. The reaction vessel contents were then kept at 160° C. for 1 hour for addition polymerization. After the addition polymerization, the temperature of the reaction vessel contents was increased to 200° C. for condensation polymerization (second condensation polymerization). The reaction time of the second condensation polymerization was adjusted so that the softening point of the contents (resin) in the reaction vessel is 120° C. Through the above, the binder resin (BP-a) was obtained.

### (Binder Resin (BP-b))

The binder resin (BP-b) was synthesized by the same method as that for the binder resin (BP-a) in all aspects other than that changes were made as follows. In the synthesis of the binder resin (BP-b), the amount of bisphenol A-ethylene oxide adduct was changed from 585 g to 732 g. Further, in the synthesis of the binder resin (BP-b), 1,838 g of bisphenol A-propylene oxide adduct was added instead of 338 g of ethylene glycol. The softening point of the binder resin (BP-b) was 106° C.

### (Binder Resin (BP-c))

The binder resin (BP-c) was synthesized by the same method as that for the binder resin (BP-a) in all aspects other than that a change was made as follows. In the synthesis of the binder resin (BP-c), 810 g of isophthalic acid was added instead of 810 g of terephthalic acid. The softening point of the binder resin (BP-c) was 108° C.

### (Binder Resin (PEs))

The binder resin (PEs) was synthesized by the same method as that for the binder resin (BP-a) in all aspects other than that changes were made as follows. In the synthesis of the binder resin (PEs), the amount of terephthalic acid was changed from 810 g to 1,080 g. Further, in the synthesis of the binder resin (PEs), the amount of bisphenol A-ethylene oxide adduct was changed from 585 g to 680 g. Also, in the synthesis of the binder resin (PEs), the amount of ethylene glycol was changed from 340 g to 450 g. Further, in the synthesis of the binder resin (PEs), the reaction vessel contents after the first condensation polymerization were directly used as the binder resin (PEs), which had a softening point of 108° C. That is, in the synthesis of the binder resin (PEs), the addition of trimellitic anhydride, acrylic acid, styrene, and dicumyl peroxide and the subsequent reaction (addition polymerization and the second condensation polymerization) were omitted.

### (Binder Resin (St))

A 10-L autoclave equipped with a thermometer, a stainless steel stirrer, and a nitrogen inlet tube was used as a reaction vessel. Into the reaction vessel, 5,000 g of ion exchanged water, 4.0 g of a partially saponified polyvinyl alcohol (“GOHSENOL (registered Japanese trademark) GM-20”, product of Nippon Synthetic Chemical Industry Co., Ltd.), 2,000 g of styrene, and 180 g of benzoyl peroxide (“NYPER (registered Japanese trademark) BW”, product of NOF Corporation) were added. Next, the air in the reaction vessel was replaced with nitrogen gas. Subsequently, while the reaction vessel contents were stirred, the temperature thereof was increased to 130° C. The reaction vessel contents were kept at 130° C. for 1 hour for addition polymerization. After the addition polymerization, the reaction vessel contents were subjected to filtration, washing, dehydration, and drying to obtain the binder resin (St), which had a softening point of 107° C.

### [Preparation of Charge Control Agent]

Charge control agents (CCR-a) and (CCR-b) were synthesized by the following methods. The charge control agents (CCR-a) and (CCR-b) were styrene-acrylic resins each having a quaternary ammonium group.

### (Synthesis of Charge Control Agent (CCR-a))

Into a 2-L flask (a reaction vessel) equipped with a stirrer, a condenser, a thermometer, and a nitrogen inlet tube, 270 g of isobutanol, 27 g of diethylaminoethyl methacrylate, and 27 g of methyl paratoluenesulfonate were added. Next, the air in the reaction vessel was replaced with nitrogen gas. The temperature of the reaction vessel contents was then kept at 80° C. for 1 hour under stirring of the reaction vessel contents for quaternization of diethylaminoethyl methacrylate. Through the above, a quaternary ammonium salt derived from diethylaminoethyl methacrylate (a salt of the compound (A)) was obtained.

Thereafter, while the nitrogen atmosphere is maintained, 315 g of styrene, 108 g of butyl acrylate, and 18 g of t-butylperoxy-2-ethylhexanoate as a peroxide-based initiator were added into the reaction vessel. While the reaction vessel contents were stirred, the temperature thereof was increased to 95° C. Next, the contents of the reaction vessel were kept at 95° C. under stirring for 3 hours for addition polymerization. Subsequently, while the nitrogen atmosphere is maintained, 9 g of t-butylperoxy-2-ethylhexanoate was further added into the reaction vessel. Next, the contents of the reaction vessel were kept at 95° C. under stirring for 3 hours to treat remaining monomers. Through the above, a polymer solution was obtained. The polymer solution was heat-dried under reduced pressure to remove a solvent portion, and the resultant solid content was deaggregated to obtain the charge control agent (CCR-a).

### (Synthesis of Charge Control Agent (CCR-b))

Into a 5-L flask (a reaction vessel), 500 g of the above-described charge control agent (CCR-a), 500 g of benzyltributylammonium-4-hydroxynaphthalene-l-sulfonate, and 1,000 g of methyl ethyl ketone as a solvent were added. Thereafter, while the reaction vessel contents were stirred, the temperature thereof was increased to a temperature at which a solid portion was dissolved in the solvent (first temperature increase). Subsequently, while the reaction vessel contents were stirred, the temperature thereof was increased to 140° C. (second temperature increase). In the second temperature increase, after the solvent started to boil, vaporized solvent was discharged out of the reaction vessel. While the temperature of the reaction vessel contents was kept at 140° C., the pressure inside the reaction vessel was reduced until the absolute pressure became no greater than 10 kPa. Through the above, the solvent was removed from the reaction vessel contents. As a result, a molten resin was obtained. The molten resin component was taken out of the reaction vessel, cooled, and pulverized to obtain the charge control agent (CCR-b).

### (Charge Control Agent (CCA))

As a charge control agent (CCA), a nigrosine dye “BONTRON (registered Japanese trademark) N-04” produced by Orient Chemical Industries, Co., Ltd. was prepared. The charge control agent (CCA) was a charge control agent which was not a styrene-acrylic resin having a quaternary ammonium group.

### <Production of Toner>

Toners A to G of Examples 1 to 7 and toners h to 1 of Comparative Examples 1 to 5 were produced by the following methods. Table 1 below shows the composition of toner mother particles included in each toner.

### Example 1

An FM mixer (“FM-20B”, product of Nippon Coke & Engineering Co., Ltd.) was charged with 2,040 g (100 parts by mass) of the binder resin (BP-a), 1,600 g (78.4 parts by mass) of a magnetic powder (“MAGNETITE MRO-15A”, product of Toda Kogyo Corp., number average primary particle diameter 0.18 μm), 200 g (9.8 parts by mass) of the charge control agent (CCR-a), and 160 g of a carnauba wax (“CARNAUBA WAX No. 1”, product of S. Kato & Co.) as a releasing agent. The contents of the FM mixer were mixed at a rotational speed of 200 rpm for 5 minutes.

The resultant mixture was melt-kneaded using a twin screw extruder (“TEM-265S”, product of Toshiba Machine Co., Ltd.) under conditions of a material feeding speed of 75 g/min, a shaft rotational speed of 100 rpm, and a set temperature (a cylinder temperature corresponding to a melt-kneading temperature) of 120° C. The resultant melt-kneaded product was cooled, and then coarsely pulverized using a pulverizer (“ROTOPLEX (registered Japanese trademark) 16/8, product of Hosokawa Micron Corp.”). The resultant coarsely pulverized product was finely pulverized using a pulverizer (“TURBO MILL Type TA”, product of Freund-Turbo Corp.). The resultant finely pulverized product was introduced into a jet mill (“MJT-1”, product of Hosokawa Micron Corp.) to be classified while being further finely pulverized. Through the above, toner mother particles were obtained.

An FM mixer (“FM-10C”, product of Nippon Coke & Engineering Co., Ltd.) was charged with 200 g of the above-described toner mother particles, and 2 g of silica particles (“AEROSIL (registered Japanese trademark) REA90”, product of Nippon Aerosil Co., Ltd., BET specific surface area: 90 m²/g, volume median diameter (D₅₀): 20 nm) as an external additive. The contents of the FM mixer were mixed at a rotational speed of 2,000 rpm for 5 minutes. The resultant mixture was sieved using a 200-mesh sieve (opening: 75 μm). Through the above, the toner A of Example 1, which included toner mother particles and an external additive attached to surfaces of the toner mother particles, was obtained.

### Examples 2 to 7 and Comparative Examples 1 to 5

Toners B to G of Examples 2 to 7 and toners h to 1 of Comparative Examples 1 to 5 were produced by the same method as that for the production of the toner A of Example 1 in all aspects other than that types and amounts of the binder resin, the magnetic powder, the charge control agent, and the releasing agent were changed to those shown in Table 1 below.

The column “Binder resin” for Comparative Example 4 in Table 1 below indicates that a mixture of 370 g of the binder resin (PEs) and 1,670 g of the binder resin (St) was used as the binder resin.

TABLE 1

| | | Toner mother particles | | | | | | |
|---|---|---|---|---|---|---|---|---|
| | | | | Magnetic | | | | Releasing |
| | | Binder resin | | powder | Charge control agent | | | agent |
| | | | Amount | Amount | | Amount | Content | Amount |
| | Toner | Type | [g] | [g] | Type | [g] | [% by mass] | [g] |
| Example 1 | A | BP-a | 2040 | 1600 | CCR-a | 200 | 5.0 | 160 |
| Example 2 | B | BP-a | 1986 | 1558 | CCR-a | 300 | 7.5 | 156 |
| Example 3 | C | BP-a | 2040 | 1600 | CCR-b | 200 | 5.0 | 160 |
| Example 4 | D | BP-a | 2104 | 1651 | CCR-a | 80 | 2.0 | 165 |
| Example 5 | E | BP-a | 1933 | 1516 | CCR-a | 400 | 10.0 | 152 |
| Example 6 | F | BP-b | 2040 | 1600 | CCR-a | 200 | 5.0 | 160 |
| Example 7 | G | BP-c | 2040 | 1600 | CCR-a | 200 | 5.0 | 160 |
| Comparative | h | BP-a | 2126 | 1667 | CCR-a | 40 | 1.0 | 167 |
| Example 1 | | | | | | | | |
| Comparative | i | BP-a | 1824 | 1432 | CCR-b | 600 | 15.0 | 144 |
| Example 2 | | | | | | | | |
| Comparative | j | PEs | 2040 | 1600 | CCR-a | 200 | 5.0 | 160 |
| Example 3 | | | | | | | | |
| Comparative | k | PEs/St | 370/1670 | 1600 | CCR-a | 200 | 5.0 | 160 |
| Example 4 | | | | | | | | |
| Comparative | l | BP-a | 2040 | 1600 | CCA | 200 | 5.0 | 160 |
| Example 5 | | | | | | | | |

The isoelectric point and the time constant T of each toner were measured by the following methods. The measurements were made at a temperature of 20° C. and a relative humidity of 65%. Table 2 below shows the measurement results.

### [Measurement of Isoelectric Point]

To prepare an aqueous solution of a surfactant having a concentration of 10%, 10 parts by mass of a nonionic surfactant (“EMULGEN (registered Japanese trademark) 120”, product of Kao Corporation, ingredient: polyoxyethylene lauryl ether) and 90 parts by mass of ion exchanged water were mixed. To 2 mL of the resultant aqueous surfactant solution, 50 mg of a measurement target (specifically, one of the toners A to G and h to l) was added, and then ultrasonic wave irradiation (frequency: 40 kHz, output power: 500 W, irradiation time: 1 minute) was performed. Through the above, a toner dispersion was obtained. Thereafter, the toner dispersion was diluted 50 times with ion exchanged water. The diluted toner dispersion was used as a measurement solution.

To the measurement solution, 0.1 N aqueous solution of sodium hydroxide was added to adjust the pH of the measurement solution to 11.00. The zeta potential of the measurement solution at pH 11.00 was measured using a laser Doppler zeta potential analyzer (“ELSZ-1000”, product of Otsuka Electronics Co., Ltd.). Thereafter, zeta potential measurement was performed using the above-mentioned zeta potential analyzer while the pH of the measurement solution at pH 11.00 was gradually decreased by adding dropwise a 0.1 N nitric acid aqueous solution. This operation was continued until the pH of the measurement solution reached 3.00. That is, the isoelectric point of the measurement sample was measured in the measurement range of pH 3.00 to pH 11.00. The isoelectric point of the measurement target was calculated based on the measurement results.

### [Measurement of Time Constant T]

A measurement target (specifically, one of the toners A to G and h to l) in an amount of 20 mg was sandwiched between electrodes of “SE-43 Electrodes for Powder” produced by Ando Electric Co., Ltd. Then, a load of 40 kgf/cm² was applied to pelletize (to a thickness of 100 μm) the measurement sample. Next, a frequency response analyzer (“1260 Frequency Response Analyzer”, product of Solartron Analytical) was connected to the above electrodes. Then, with the use of the frequency response analyzer, electrical characteristics of the measurement sample were measured to prepare a Cole-Cole plot. The measurement conditions of the electrical characteristics included a voltage of 10 Vpp, a frequency range of 40 Hz to 100 kHz (5 pt/decade), and a number of measurement times of 3 cycles. Subsequently, fitting was made regarding the measurement sample as an equivalent parallel resistor-capacitor (RC) circuit to measure the electrical resistance and the permittivity of the measurement sample. Thereafter, the time constant τ [sec] (product of electric resistance and permittivity) was calculated based on the electric resistance and the permittivity of the measurement sample.

### <Evaluation>

The amount of charge, developability (image density), and toner layer turbulence on a development sleeve were evaluated for each toner by the methods described below. Table 2 below shows the evaluation results.

An evaluation apparatus used in each evaluation was a monochrome printer (“ECOSYS (registered Japanese trademark) FS-P3060DN”, product of KYOCERA Document Solutions Inc.). An evaluation target (one of the toners A to G and h to l) was loaded in a black-color development device of the evaluation apparatus. A toner for replenishment use (the same toner as the evaluation target toner) was loaded in a black-color toner container of the evaluation apparatus.

### [Developability]

Using the evaluation apparatus, a text document having a coverage rate of 1% was printed in a duplex printing mode on 5,000 sheets of printing paper in a normal temperature and normal humidity environment at a temperature of 23° C. and a relative humidity of 50%. Thereafter, an evaluation image including a solid image was printed on a sheet of printing paper. Using a reflectance densitometer (“TC-6D”, product of Tokyo Denshoku Co., Ltd.), the image density (ID) of the solid image of the printed matter on which the evaluation image had been printed was measured. For developability, each toner was evaluated as “good (A)” if the image density (ID) was at least 1.20 and evaluated as “poor (B)” if the image density (ID) was less than 1.20.

### [Amount of Charge]

The development device and a photosensitive drum were taken out of the evaluation apparatus after the evaluation of developability. Using a Q/m meter (“MODEL 210HS-1”, product of Trek, Inc.), toner was sucked from the toner layer in a region of the development sleeve of the developing device corresponding to a portion thereof immediately before the development nip part, and an amount of charge [μC/g] thereof (amount of charge on the sleeve) was measured. Further, using the above-mentioned Q/m meter, toner was sucked from a region of the photosensitive drum corresponding to a portion thereof immediately after the developing nip part, and an amount of charge [μC/g] thereof (amount of charge on the drum) was measured. A toner having a larger amount of charge tends to have better developability, and is therefore preferable. However, an extremely large amount of charge (for example, an amount of charge of 8.5 μC/g or more) of a toner tends to result in occurrence of toner layer turbulence on a development sleeve, and is therefore not preferable.

### [Toner Layer Turbulence]

Using the evaluation apparatus, a text document having a coverage rate of 1% was printed in a duplex printing mode on 5,000 sheets of printing paper in a low temperature and low humidity environment at a temperature of 10° C. and a relative humidity of 15%. Thereafter, the development device was taken out of the evaluation apparatus, and a development sleeve of the development device was visually observed. For toner layer turbulence, a case in which no toner layer turbulence was observed on the development sleeve was evaluated as “good (A)” and a case in which toner layer turbulence was observed on the development sleeve was evaluated as “poor (B)”.

TABLE 2

| | | | Time | Amount of charge | | | Toner |
|---|---|---|---|---|---|---|---|
| | | Isoelectric | constant | [μC/g] | | Developability | layer |
| | Toner | point | τ [s] | On sleeve | On drum | ID | turbulence |
| Example 1 | A | 3.48 | 1.23 | 5.76 | 7.94 | 1.27 | A |
| Example 2 | B | 4.21 | 0.531 | 3.55 | 5.93 | 1.25 | A |
| Example 3 | C | 3.71 | 8.33 | 6.63 | 6.49 | 1.23 | A |
| Example 4 | D | 3.05 | 5.17 | 5.41 | 5.67 | 1.28 | A |
| Example 5 | E | 4.83 | 0.243 | 3.02 | 5.62 | 1.25 | A |
| Example 6 | F | 3.37 | 2.24 | 5.32 | 7.88 | 1.31 | A |
| Example 7 | G | 3.42 | 2.11 | 5.35 | 8.12 | 1.30 | A |
| Comparative | h | 2.89 | 9.74 | 5.99 | 5.92 | 1.05 | A |
| Example 1 | | | | | | | |
| Comparative | i | 6.99 | 1.77 | 9.65 | 11.22 | 1.39 | B |
| Example 2 | | | | | | | |
| Comparative | j | 3.32 | 31.7 | 5.81 | 5.27 | 1.08 | A |
| Example 3 | | | | | | | |
| Comparative | k | 4.16 | 0.0831 | 1.65 | 4.37 | 0.97 | A |
| Example 4 | | | | | | | |
| Comparative | l | 4.67 | 0.0221 | 1.02 | 2.43 | 0.53 | A |
| Example 5 | | | | | | | |

The toners A to G of Examples 1 to 7 each included toner particles. The toner particles each included a toner mother particle. The toner mother particles contained a binder resin, a magnetic powder, and a charge control agent. The binder resin included a block polymer. The block polymer had a polyester portion and a vinyl polymer portion. The charge control agent included a styrene-acrylic resin having a quaternary ammonium group. A content percentage of the charge control agent in the toner mother particles was at least 1.5% by mass and no greater than 12.0% by mass. As shown in Table 2, each of the toners A to G of Examples 1 to 7 was excellent in developability and was capable of inhibiting occurrence of toner layer turbulence on the development sleeve.

By contrast, developability was poor or toner layer turbulence on the development sleeve occurred as for each of the toners h to l of Comparative Examples 1 to 5 not having the above-described constitution.

Specifically, the toner h of Comparative Example 1 had a content percentage of the charge control agent of less than 1.5% by mass. It is determined that as a result of the content percentage of the charge control agent being less than 1.5% by mass, developability of the toner h of Comparative Example 1 was lowered, leading to formation of an image having insufficient image density.

The toner i of Comparative Example 2 had a content percentage of the charge control agent of greater than 12.0% by mass. It is determined that as a result of the content percentage of the charge control agent being greater than 12.0% by mass, the toner i of Comparative Example 2 was excessively charged, leading to occurrence of toner layer turbulence.

The binder resin contained in the toner j of Comparative Example 3 included no block polymer. It is determined that as a result of the binder resin containing no block polymer, the charge control agent was excessively dispersed in the binder resin, leading to an increase in the time constant T of the toner j of Comparative Example 3. Accordingly, the toner j of Comparative Example 3 had a wide charge amount distribution of the toner, leading to developability lowering.

The binder resin contained in the toner k of Comparative Example 4 contained a polyester resin and a styrene resin. It is determined that as a result of the binder resin containing a polyester resin and a styrene resin, the charge control agent was not sufficiently dispersed in the binder resin, leading to an excessive decrease in the time constant τ of the toner k of Comparative Example 4. Accordingly, charge neutralization was caused in the toner k of Comparative Example 4, leading to developability lowering.

The charge control agent contained in the toner l of Comparative Example 5 did not include a styrene-acrylic resin having a quaternary ammonium group. It is determined that as a result of the charge control agent not including a styrene-acrylic resin having a quaternary ammonium group, dispersibility of the charge control agent was not controllable in the toner l of Comparative Example 5, leading to insufficient dispersion of the charge control agent in the binder resin, which caused an excessive decrease in the time constant τ. Accordingly, charge neutralization was caused in the toner l of Comparative Example 5, leading to developability lowering.

What is claimed is:

1. A toner comprising toner particles, wherein
the toner particles each include a toner mother particle,
the toner mother particles contain a binder resin, a magnetic powder, and a charge control agent,
the binder resin includes a block polymer,
the block polymer has a polyester portion and a vinyl polymer portion,
the charge control agent includes a styrene-acrylic resin having a quaternary ammonium group, and
a content percentage of the charge control agent in the toner mother particles is at least 1.5% by mass and no greater than 12.0% by mass.

2. The toner according to claim 1, wherein
a time constant τ of the toner is at least 0.10 seconds and no greater than 20.00 seconds at a temperature of 20° C. and a relative humidity of 65%.

3. The toner according to claim 1, wherein
an isoelectric point of the toner as measured by zeta potential measurement in water is at least 3.00 and no greater than 5.00.

4. The toner according to claim 1, wherein
the block polymer further has a linker that links the polyester portion and the vinyl polymer portion, and
the linker is derived from a specific compound having a vinyl group and at least one of a carboxy group and an alcoholic hydroxyl group.

5. The toner according to claim 4, wherein
the specific compound includes (meth)acrylic acid.

6. The toner according to claim 1, wherein
the styrene-acrylic resin having a quaternary ammonium group includes a repeating unit derived from a compound represented by general formula (1) shown below 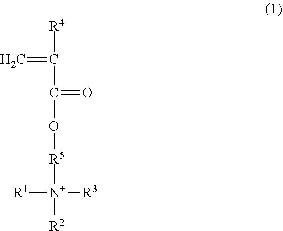
where in the general formula (1), R¹ to R³ each represent, independently of one another, an alkyl group having a carbon number of at least 1 and no greater than 5, R⁴ represents a hydrogen atom or a methyl group, and R⁵ represents an alkylene group having a carbon number of at least 1 and no greater than 5.
